(19) United States
(12) Patent Application Publication
(10) Pub. No.: US 2016/0157575 A1
(43) Pub. Date: Jun. 9, 2016

(54) Illuminated Purse

(71) Applicants: Howard Britten, Apopka, FL (US); Dorothy Britten, Apopka, FL (US); Howard Britten, JR., Clermont, FL (US)

(72) Inventors: Howard Britten, Apopka, FL (US); Dorothy Britten, Apopka, FL (US); Howard Britten, JR., Clermont, FL (US)

(21) Appl. No.: 14/959,472

(22) Filed: Dec. 4, 2015

Related U.S. Application Data
(60) Provisional application No. 62/087,323, filed on Dec. 4, 2014.

(51) Int. Cl. A45C 15/06; F21L 4/00; F21V 23/04

(52) U.S. Cl. CPC A45C 15/06; F21V 23/04; F21V 23/0471; F21L 4/00; F21Y 2101/02

(57) ABSTRACT

An illuminated purse for allowing users to more easily view the interior of the purse. The illuminated purse includes a body forming an interior volume configured to store personal items therein. The interior volume is accessible via an opening that is temporarily sealed by a fastener. A lighting assembly is disposed within the interior volume of the body in order to improve visibility of personal items therein. The lighting assembly includes a power source, an activation switch, a motion sensor, a microprocessor, and a plurality of LEDs. The sensor is configured to detect a user reaching into the interior volume, thereby triggering a signal to the microprocessor to activate the plurality of LEDs disposed within the housing.

### CROSS REFERENCE TO RELATED APPLICATION

This application claims the benefit of U.S. Provisional Application No. 62/087,323 filed on Dec. 4, 2014. The above identified patent application is herein incorporated by reference in its entirety to provide continuity of disclosure.

### FIELD OF THE INVENTION

The present invention relates to purses and other handbags. More specifically, the present invention pertains to an improved purse that includes a lighting assembly that illuminates the interior volume of the purse in order to allow a user to more easily view and retrieve items placed therein.

### BACKGROUND OF THE INVENTION

Handbags, purses, and other similar articles are designed to hold personal items therein. Handbags and purses are often carried for a variety of reasons, however, most users carry a very similar set of essential personal items with them at all times. These personal items usually include identification materials, such as a driver's license, transactional items, such as cash and credit cards, and personal care items, such as medications and cosmetics. Handbags and purses provide users with a convenient way of storing all these personal items in one location.

One of the most common problems associated with handbags and purses is that the interior of the bag is dark, and as a result users often have a difficult time locating personal items therein, especially at night or in dimly lit conditions. Often the problem is exacerbated because the handbags and purses are filled with various personal items. Thus, searching for personal items stored within a handbag or purse can be frustrating and time-consuming. Accordingly, there exists a need for a purse that includes a lighting assembly that illuminates the interior volume of the purse to aid a user in searching for items stored therein.

Devices have been disclosed in the prior art that relate to illuminated purses. These include devices that have been patented and published in patent application publications. Some devices provide illuminated purses with interior lighting comprising a battery source, a magnetic switching means, and LED lights. Other devices provide purses having lighting sources built within the bottom side of the purse. These devices, however, fail to provide an illuminated purse having a sensor, and a padded member, and a plurality of LEDs.

The present invention provides an illuminated purse having a housing forming an interior volume that is accessible through an opening. The opening is operably sealed via a fastener, preferably a zip fastener. A lighting assembly is disposed on an interior side of the housing configured to illuminate the interior volume to facilitate the retrieval of personal items stored therein. The lighting assembly includes a power source, an activation switch, a sensor, a microprocessor, and a plurality of LEDs. The sensor is configured to detect movement and transmit a signal to the microprocessor to activate the plurality of LEDs. The plurality of LEDs is disposed on an interior side of the housing, wherein at least one LED is disposed on a padded member placed against a base portion of the housing.

It is therefore submitted that the present invention is substantially divergent in design elements from the prior art, and consequently it is clear that there is a need in the art for an improvement to illuminated purses. In this regard, the instant invention substantially fulfills these needs.

### SUMMARY OF THE INVENTION

In view of the foregoing disadvantages inherent in the known types of illuminated purses now present in the prior art, the present invention provides an illuminated purse wherein the same can be utilized for providing illumination of the interior of the purse and the contents thereof.

It is therefore an object of the present invention to provide a new and improved illuminated purse that has all of the advantages of the prior art and none of the disadvantages.

Another object of the present invention is to provide a new and improved illuminated purse having a housing forming an interior volume that is accessible via an opening.

Yet another object of the present invention is to provide a new and improved illuminated purse, wherein a fastener is configured to allow the user to open and close the opening.

Still yet another object of the present invention is to provide a new and improved illuminated purse further comprising a lighting assembly configured to illuminate the interior volume of the purse to facilitate the retrieval of personal items stored therein.

Yet a further object of the present invention is to provide a new and improved illuminated purse, wherein the lighting assembly includes a power source, an activation switch, a sensor, and a plurality of LEDs.

A further object of the present invention is to provide a new and improved illuminated purse, wherein a motion sensor is configured to detect a user reaching into the interior volume so as to activate the plurality of LEDs disposed therein.

Still yet another object of the present invention is to provide a new and improved illuminated purse, wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of the illuminated purse.

FIG. 2 shows a side cross sectional view of the illuminated purse.

FIG. 3 shows a schematic diagram of the illuminated purse.

### DETAILED DESCRIPTION OF THE INVENTION

Reference is made herein to the attached drawings. Like reference numerals are used throughout the drawings to depict like or similar elements of the illuminated purse. For the purposes of presenting a brief and clear description of the present invention, the preferred embodiment will be discussed as used for illuminating the interior volume of a purse to facilitate the retrieval of personal items. The figures are intended for representative purposes only and should not be considered to be limiting in any respect.

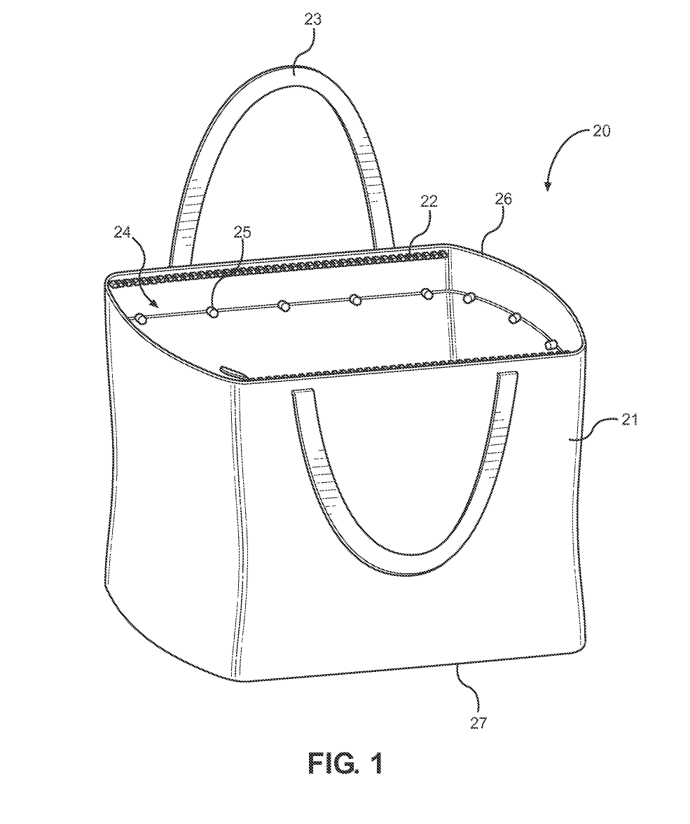

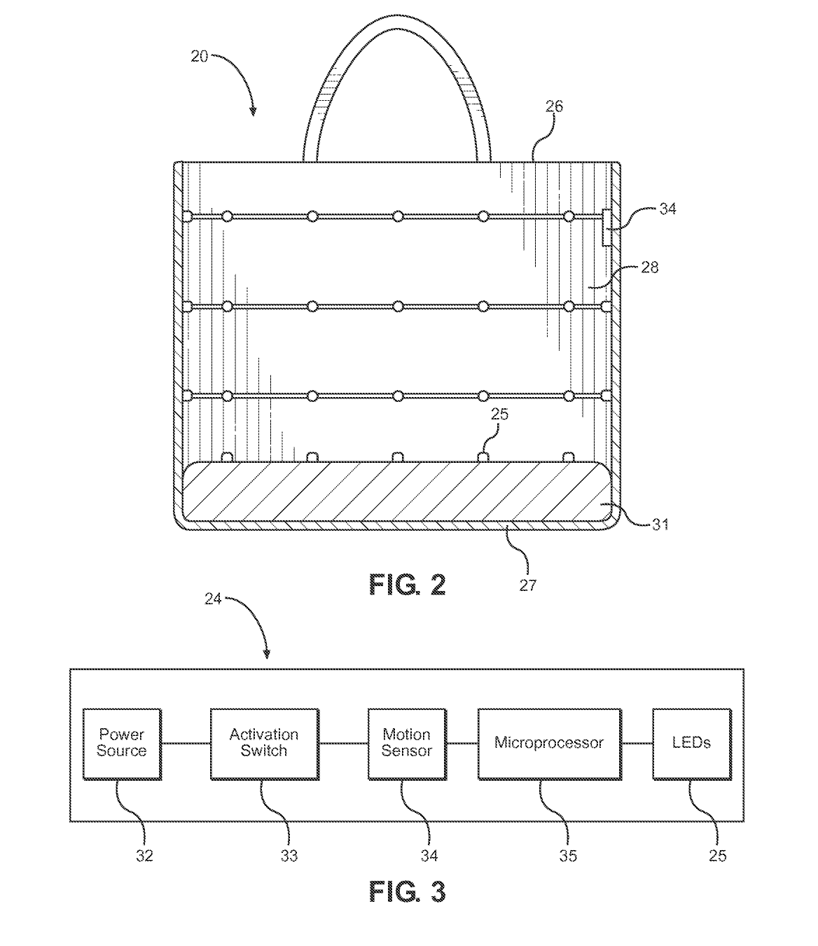

Referring now to FIGS. 1 and 2, there is shown a perspective view of the illuminated purse and a side cross sectional view, respectively. The purse 20 comprises a body 21 having an open upper end 26 and a closed lower end 27, wherein the body 21 defines a hollow interior volume 28. The purse 20 can resemble any of various types of handbags including clutches, totes, and satchels, among others. In the illustrated embodiment, the body 21 is shown as having a rectangular configuration, however, in alternate embodiments, the body 21 can have any of various other configurations. The open upper end 26 provides access to the interior volume 28, wherein a fastener 22 is disposed on the open upper end 26 that can be fastened so as to removably seal the opening of the illuminated purse 20. Preferably, the fastener 22 is a zipper, however, other suitable types of fasteners are used in alternate embodiments, such as buttons, clasps, snaps, or a magnetic fastener, among others.

The body 21 further includes at least one strap 23 configured to allow the user to more easily carry the purse 20. The strap 23 can include any of various types of straps, such as a hand strap, a shoulder strap, or a cross body strap, among others. The strap 23 can be composed of any of various materials, such as a fabric material, leather, a chain, or the like. Preferably, a pair of straps 23 are positioned on opposing sides of the open upper end 26 of the body 21.

A lighting assembly 24 is affixed to the interior of the body 21 of the purse 20. The lighting assembly 24 provides illumination within the interior volume so as to facilitate the retrieval of personal items stored therein. In this way, the user can more easily see and find items stored within the interior volume of the purse 20. The lighting assembly 24 uses a plurality of light emitting diode (LEDs) 25, wherein the LEDs are affixed to the interior walls and lower end of the body 21 of the purse 20. The lighting assembly 24 further comprises electrically conducting cables and other circuitry necessary to provide electricity to power the LEDs.

The lighting assembly 24 further comprises a motion sensor 34 adapted to detect movement within the purse 20. In this way, the motion sensor 34 is adapted to detect when a user inserts his or her hand into the purse 20 in order to retrieve an item therein. The motion sensor 34 is operably connected to a microprocessor and to the LEDs 25 such that when motion is detected by the motion sensor 34, the LEDs 25 automatically illuminate. The LEDs 25 are adapted to remain illuminated for a predetermined period of time, such as sixty seconds, in order to allow the user to retrieve an item before the illumination terminates. When the purse is closed and no motion is detected by the motion sensor 34, the LEDs are no longer illuminated. In alternate embodiments, other types of sensors are used in order to determine if the purse is opened and a user is attempting to retrieve items therefrom.

The lower end 27 of the interior volume 28 of the purse 20 comprises a padded member 31 thereon. The padded member 31 is preferably composed of foam or a similar material and helps to provide cushioning to items placed within the purse 20. Further, the padded member 31 preferably includes the light assembly 24 circuitry and electrical components therein, so that the circuitry is not exposed within the interior volume 28 of the purse 20.

Referring now to FIG. 3, there is shown a schematic diagram of the lighting assembly 24. The light assembly 24 includes a power source 32, an activation switch 33, a motion sensor 34, a microprocessor 35, and the plurality of LEDs 25. The power source 32 is preferably a disposable or rechargeable battery, however, other sources of voltage are likewise contemplated. The activation switch 33 is preferably positioned within the interior volume of the purse 20. The activation switch 33 can be actuated in order to deactivate the lighting assembly 24 when additional light is not needed, such as during the day or while outdoors.

The motion sensor 34 of the lighting assembly 24 is configured to detect movement, specifically when the user is reaching within the interior volume of the purse 20. Upon detection of movement, the motion sensor 34 transmits a signal to the microprocessor 26 to activate the LEDs 25 for a predetermined period of time. In alternate embodiments, other types of sensors are used. The sensor 34 may be a passive infrared radiation (PIR) based motion detector.

It is not desired at this time to limit the range that the sensor 34 detects, rather, it is desired to disclose and claim a functional sensor 34 for obtaining the results and advantages described herein. It is contemplated that this range of detection for the sensor 34 is readily discernible by those of ordinary skill within the art, and modifications and variations envisioned by those of ordinary skill within the art are deemed to be within the scope of invention embodiments described herein.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An illuminated purse, comprising:
a body having an open upper end, a closed lower end, and an interior volume in which objects can be stored;
at least one strap attached to said body;
a lighting assembly comprising a plurality of LED lights positioned within the interior volume of the body, wherein the plurality of LED lights are configured to illuminate when a user reaches into the interior volume of the body.

2) The illuminated purse of claim 1, wherein said lighting assembly further comprises a power source, a microprocessor, a motion sensor, and an activation switch.

3) The illuminated purse of claim 2, the motion sensor is positioned within the interior volume of the body in order to detect motion within the body.

4) The illuminated purse of claim 2, wherein said sensor includes a passive infrared radiation based motion detector.

5) The illuminated purse of claim 2, wherein the power source comprises one or more batteries.

6) The illuminated purse of claim 1, further comprising a padded member disposed within the interior volume of the body on a lower end thereof, wherein the padded member provides cushioning to objects placed within the body.

7) The illuminated purse of claim 6, wherein the plurality of LEDs are positioned on the padded member.

8) The illuminated purse of claim 1, wherein the plurality of LEDs are positioned throughout the interior volume of the body so as to provide illumination in all directions.
